(19) United States
(12) Patent Application Publication
(10) Pub. No.: US 2010/0070407 A1
(43) Pub. Date: Mar. 18, 2010

(54) SYSTEM AND METHOD FOR ON-LINE LENDING WITH EARLY WARNING SYSTEM

(75) Inventors: Teresa Rose, Holly Springs, NC (US); Patricia Kinney, Cary, NC (US); Douglas Joe Zickafoose, Raleigh, NC (US); Brian Newlin, Raleigh, NC (US); Jennifer Weaver, Raleigh, NC (US); Steven Picard, Winston-Salem, NC (US)

Correspondence Address: DUANE MORRIS LLP - DC, 505 9th Street, Suite 1000, WASHINGTON, DC, 20004-2166, US

(73) Assignee: Branch Banking and Trust Company, Raleigh, NC (US)

(21) Appl. No.: 12/561,125

(22) Filed: Sep. 16, 2009

Related U.S. Application Data
(63) Continuation-in-part of application No. 12/530,188.
(60) Provisional application No. 61/097,381, filed on Sep. 16, 2008.
(60) Provisional application No. 61/097,375, filed on Sep. 16, 2008.

(51) Int. Cl. G06Q 40/00; G06Q 10/00

(52) U.S. Cl. 705/38; 705/325; 705/35

(57) ABSTRACT

A method for interfacing with a financial institution using a computer interface is disclosed for on-line or E-Lending. The method includes an early warning evaluation of the customer and/or entities associated with the customer to identify fraudster/abusers and prevent them from opening online accounts at the financial institution.

### RELATED AND CO-PENDING APPLICATIONS

This application is a continuation in part and claims priority of co-pending non-provisional application entitled “System and Method for an Electronic Lending System”, Ser. No. 12/540,153 filed 12 Aug. 2009, which claims priority of non-provisional applications: “System and Method for Business Online Account Opening”, Ser. No. 61/088,267 filed 12 Aug. 2008; “System and Method for Retail Online Account”, Ser. No. 61/088,229 filed 12 Aug. 2008; and “System and Method for an Electronic Lending System”, Ser. No. 61/088,239 filed 12 Aug. 2008. This application also claims priority to the following co-pending provisional applications, the entirety of each is hereby incorporated herein by reference in its entirety: “BankCard Regs”, Ser. No. 61/097,381 filed 16 Sep. 2008; and “EWS Requirements”, Ser. No. 61/097,375 filed 16 Sep. 2008. Additionally, this application hereby incorporates herein by reference, in their entirety, each of the following co-pending application: “System and Method for Business Online Account Opening”, Ser. No. 12/530,188 filed 12 Aug. 2009 and “System and Method for Retail Online Account”, Ser. No. 12/540,342 filed 12 Aug. 2008. Further this application hereby incorporates herein by reference, in its entirety the follow concurrently filed application: “Method for Retail Online Account with Early Warning Methodology”, Ser. No. ______ filed 16 Sep. 2009.

### BACKGROUND

Increasingly, the public is going on-line for a variety of transactions and information. More than 30% of the population has personal computers and modems. Furthermore, over 60% of people with bank accounts have personal computers and modems. At the same time the number of people subscribing and using on-line services is greater than 40 million, and this number is growing at an exponential rate.

As the public uses computers with a greater frequency, more financial transactions are being automated and performed via computer. There is good motivation to bank on-line. On-line banking provides convenience, safety, cost savings, and potentially new types of services not readily or conveniently available via in-person banking. Such potentially new services include access to superior up-to-the minute information, on-line investment clubs, information filters, and search agents.

With the increase in the number of financial transactions performed on-line, the convenience and cost-savings of banking on-line also increases. Additionally, new and more powerful methods are being developed for protecting the security of financial transactions performed on-line. The result is that convenience, cost savings and enhanced security have combined to make on-line financial services more useful and effective, thereby driving the development of newer and more integrated services. More sophisticated financial systems that offer greater integration and a high degree of user control enable on-line users to synthesize, monitor, and analyze a wide array of financial transactions and personal financial data.

Currently, methods exist for users to perform a variety of on-line financial transactions. These methods however fail to offer on-line lending including qualification verifications. For example, users may bank on-line, thereby enabling performance of transactions, such as transfers from one account to another, but must already have an established account or line of credit in the financial institution.

In view of the increase of electronic commerce in the market place the present subject matter discloses a unique on-line account opening method. The disclosed subject matter enables a stream-lined entry to an on-line lending presence.

A method is needed in which customers may apply for a loan on-line and be enrolled in financial offerings as a result of qualification and verification of the qualification based on a set of criteria.

In order to obviate the deficiencies of the prior art, the present disclosure presents a novel method for interfacing with a financial institution using a computer interface. In the method, a customer's request is received from a customer that has reached a predetermined webpage of the financial institution using a computer network. A first content is presented to the customer, and a first input is received from the customer. A customer is authenticated if the customer is determined to be an existing on-line banking customer. A first set of information is received from the customer and presented back to the customer for review.

In the method, a second set of information is further received from the customer. The terms and conditions are presented to the customer. An authorization to proceed with a credit check and an application are received from the customer. A risk analysis is performed using information received from the customer and the application of the loan is subject to approval based at least in part on the risk analysis. The third set of information is received from the customer and a fourth set of information is provided back to the customer. The fourth set of information related to the costs and schedule associated with the line of credit or loan product.

Another method is also presented for interfacing with a financial institution using a computer interface. The method includes receiving a product selection from the customer along with a first set of identification information. The method further includes a review the first set of information and a determination of the identity of the customer from the first set of information. If the customer identification cannot be made the process terminates.

A determination is made whether the customer is an existing on-line client of the financial institution and, if so, fields of the application for the selected product based on information known from the preexisting relationship are pre-populated. A third set of information is received from the customer that includes information relating to collateral, customer income, customer asset, customer liability, and combinations thereof.

The method determines an amount of the line of credit or the amount and term of loan product. Additional disclosures and an application are received from the customer for the chosen product or products.

Furthermore, the method also contemplates the implementation and use of a real time early warning system for fraud detection and identity verification during the online account opening process. The customer may undergo this real time risk screening process using the early warning system by having business rules applied to entities associated with the customer. For example, one entity associated with the customer may be identified as the name of a “single” or “primary” applicant associated with customer. Another entity may be identified as the name of a “secondary” or “joint” applicant associated with the customer. Other entities besides those listed above are contemplated by this disclosure. Of course, the “name” may also include other identifying information such as address, phone number, tax identification number, a government-issued identification number, etc. Additionally, the early warning system and/or methodology may differentiate between a customer who is currently an online client of the financial institution and a customer who is not currently an online client of the financial institution.

In a typical prior art financial institution online interfacing process, fraud detection and identity verification of a customer opening an online account may not take place until sometime after the online account has been opened and is accessible to the customer. Obviously, this puts the financial institution in a position of unnecessarily heightened risk. Earlier fraud detection and identity verification processes are necessary to reduce this unnecessary risk to the financial institution. Otherwise a fraudster may have access to a fraudulently-obtained online account before the account is shut down.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a flow chart of an embodiment of the disclosed subject matter.

FIG. 2 is a flow chart of another embodiment of the disclosed subject matter.

FIG. 3 is a flow chart representing loan or credit line approval according an embodiment of the disclosed subject matter.

FIG. 4 is a flow chart representing closing processes according to an embodiment of the disclosed subject matter.

FIG. 5 is a flow chart representing additional closing processes according to an embodiment of the disclosed subject matter.

FIG. 6 is a flow chart representing authentication of the customer according to an embodiment of the disclosed subject matter.

FIG. 7 is a flow chart representing a verification process based on the evaluation outcome of a customer's CIP according to an embodiment of the disclosed subject matter.

FIG. 8 is a flow chart of an embodiment of a method for interfacing with a financial institution comprising the disclosed early warning system subject matter.

FIG. 9 is a flow chart of another embodiment of a method for interfacing with a financial institution comprising the disclosed early warning system subject matter.

FIG. 10 is a table representing single applicant rules and joint applicant rules for an embodiment of an early warning system of the disclosed subject matter.

### DETAILED DESCRIPTION

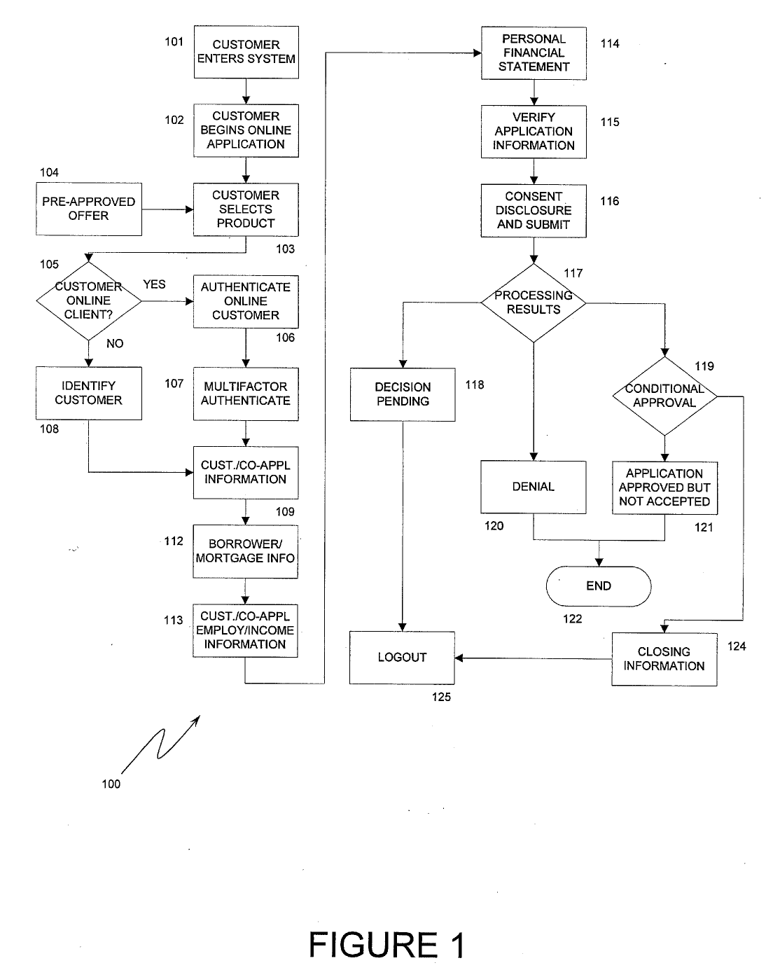

FIG. 1 illustrates a process in which a customer may apply for a loan on-line via a computer network, e.g., the Internet, by accessing and exchanging information using the website of a financial institution. The customer enters the system by accessing or being directed to the institutions' website (webpage) as shown in Block 101. In either event, a request for the website is received by the financial institution's server or proxy server. The customer is presented a list of products such as a checking account, savings account, an on-line only savings account or brokerage account or any of a number of financial products offered by the institution. These financial products may also include a deposit account, which may be in the form of a certificate of deposit, individual retirement account, retirement account, a 401(k) account, tax-deferred college savings account or combination thereof. In particular, for the present disclosure, loan and credit line products are presented to the customer. The loan and credit line products may include home loans, home equity loans, auto loans, secured loans, line of credit and unsecured loans. The selection of products presented to the customer may also be a function of path used by the customer to arrive at the website. For example, if the customer accessed the website via a hyperlink on another site directed to automobiles, only the automobile loans or secured loan products may be presented, or the entire scope of products is presented but only the automotive loan products may be highlighted. In this manner, the most relevant products based on the customer's path may be brought to the customer's attention. As part of the selection process, an on-line loan application is undertaken as shown in Block 102. Information obtained during the process may be automatically input into the application. The customer may also be provided with a set of terms and conditions which may govern the use of the website, on-line banking, application process, liabilities, etc. The terms and conditions may also include a customer check-off which may be required to continue and ensure they have been at least noticed, if not reviewed by the customer.

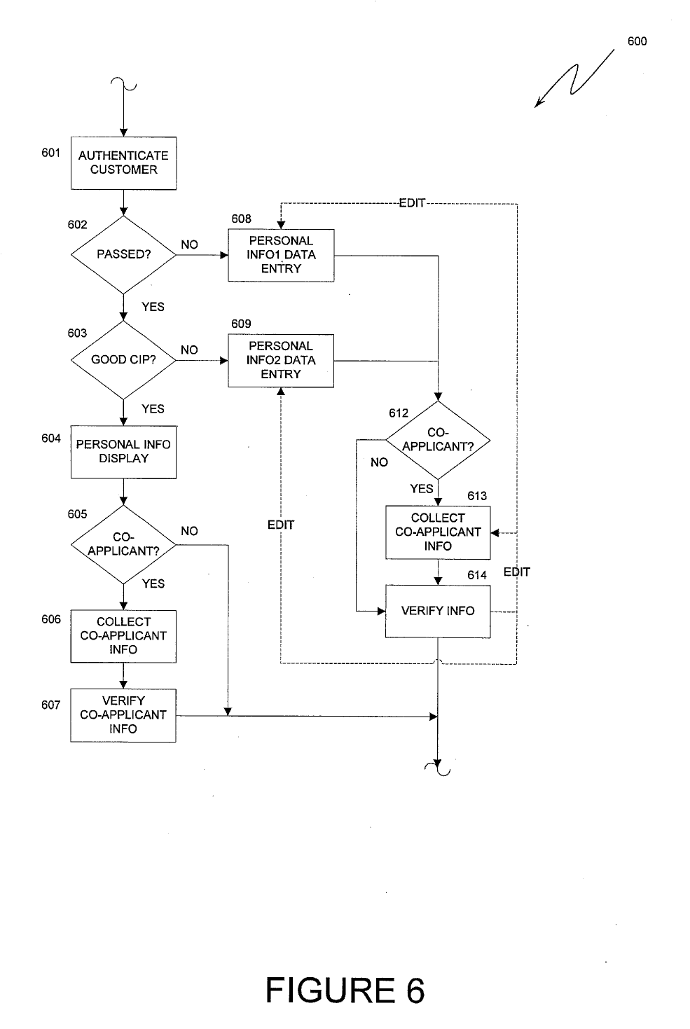

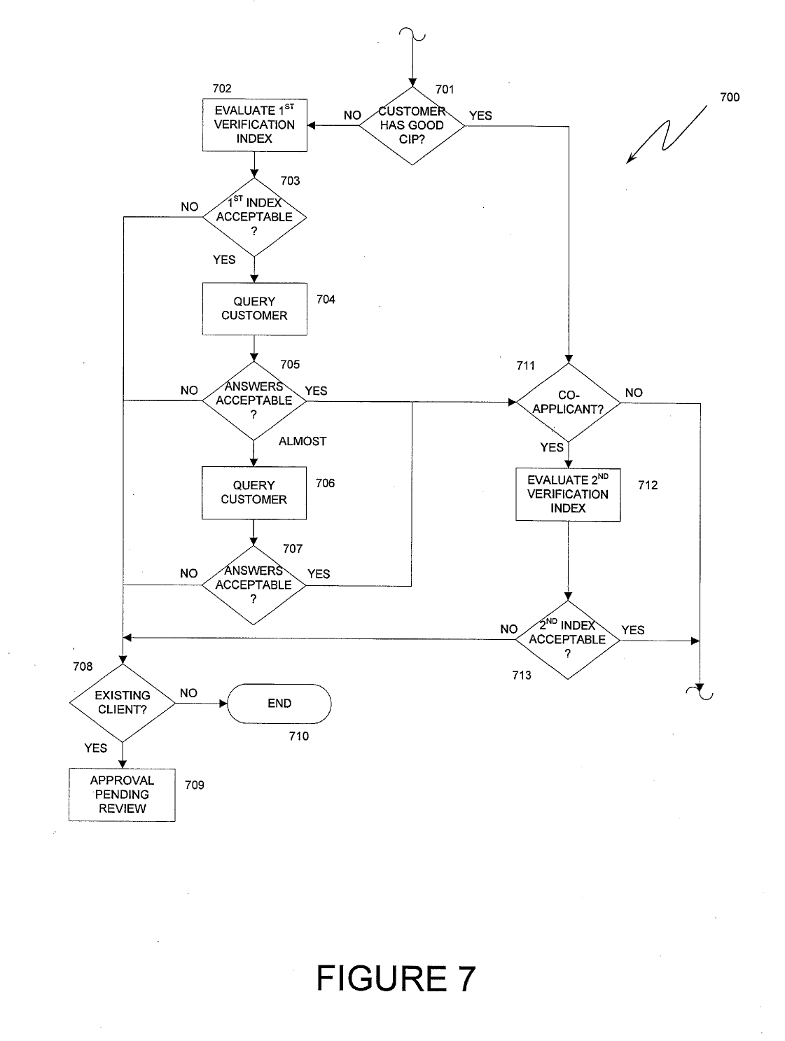

Following FIG. 1, the customer may then select a loan or line of credit product (lending product encompasses both terms hereinafter) from the products presented as shown in Block 103. The group or set of lending products may include pre-approved offers as shown in Block 104, which may also be a function of the path of access to the financial institutions website or other information associated with the customer. A determination is made in decision Block 105 of whether the customer is an existing on-line client of the financial institution. If the customer is a pre-existing on-line client, the customer is authenticated as shown in Block 106. The authentication process may match known information with information provided by the customer. In addition, known information based on the pre-existing relationship may be pre-populated in the on-line application for the convenience of the customer. Multifactor authentication may also be performed as shown in Block 107 and authentication process is described in greater detail with respect to FIG. 6. A first set of information regarding the customer and/or co-applicant is requested of and received from the customer as shown in Block 109. The information may include the name, his/her physical address, date of birth, SSN or part thereof (e.g. last four digits), contact information such as phone numbers and email addresses, citizenship, and information regarding the characteristics of the identification (e.g. type, ID Number, State of issuance, issue date and expiration date), user name, password or other identifying indicia/code that enables the identification of the customer or links the customer to the customer's established account(s) as well as information regarding a co-applicant if any. If the customer is not a current on-line client of the financial institution, the customer is identified as shown in Block 108, a process of identifying the customer is described in greater detail with respect to FIG. 7.

The first set of information may be verified. This verification may include presenting back to the customer the first set of information and accepts corrections to the first set of information the customer has made. The website may allow and request the customer to annotate, modify or otherwise change incorrect or incomplete information upon its presentation to the customer.

A second set of information is also requested and received from the customer as shown in Blocks 112, 113 and 114. This information may include borrower and mortgage information, employment and income information, as well as personal financial statements. This second set of information may include employment history, income, assets, liability, loan amount, securitization, collateral valuation, purchase amount, location of property, etc.

The information received from the customer pertinent to the lending product may be verified as shown in Block 115 and a consent disclosure is solicited and received from the customer as shown in Block 116. The consent disclosure may include consent to a credit check and gathering other personal or financial information.

As part of the processing of the application for the selected lending product, a risk assessment/analysis is performed using information contained in the application as well as information known from internal and external sources as shown in Block 117. The risk analysis is performed on the customer to determine if the customer's activities present an unacceptable or acceptable risk. If the risk analysis yields an unfavorable result indicating the customer is high risk, the loan may not be approved on-line. In such a case the customer may be required to appear in person to facilitate the lending product.

As a result of processing the information the customer's application is conditionally approved, denied, or placed in pending status. If the decision is pending as shown in Block 118, further on-line processing ends and off-line processing may commence. If as a result of the processing, a denial is issued as shown in Block 120, the customer is informed and the processing of the application for the selected product terminates as shown in Block 122. If the application is conditionally approved as shown in Block 119, the terms and conditions for the lending product are presented to the customer. The terms and conditions may include an electronic disclosure, a retail bank services agreement, a pricing guide, a corporate privacy notice, and a tax identification number certification as well as others common to the industry. If the customer does not accept the lending offer as shown in Block 121, the application process terminates as shown in Block 122. If the customer accepts the offer, additional information is required from the customer. This additional information may include insurance information including homeowners, hazard insurance, flood insurance, auto insurance etc. and may include information on desired closing agent or attorney and title company.

Closing information is then presented to the customer as shown in Block 124. The closing information may include Real Estate Settlement Procedures Act (RESPA) information, a good faith estimate of the settlement costs, home loan amortization schedule, client identification profile, servicing disclosures, and line of credit information, home equity line of credit information, home loan information, automobile loan, boat loan and other loan information.

Along with the closing information, the customer may be presented a summary of the lending product selected by the customer and other information such as the nearest branch location and other information a borrower may find useful. Contact information including phone number, addresses, email addresses and web pages may be presented to the customer during this presentation.

Additional products and offers may also be communicated to the customer subsequent to the closing information, these products and offers may be only tangentially related or provided by third parties, these advertisements may also be presented based on the information collected during the on-line process and may be selected by the financial institution. Selection by the financial institution prevents the unwanted disclosure of private information but still allows the advertising to be marketed based on financial status. For this additional product offering, the customer may be connected to another site. The customer may then logout of the application process as shown in Block 125.

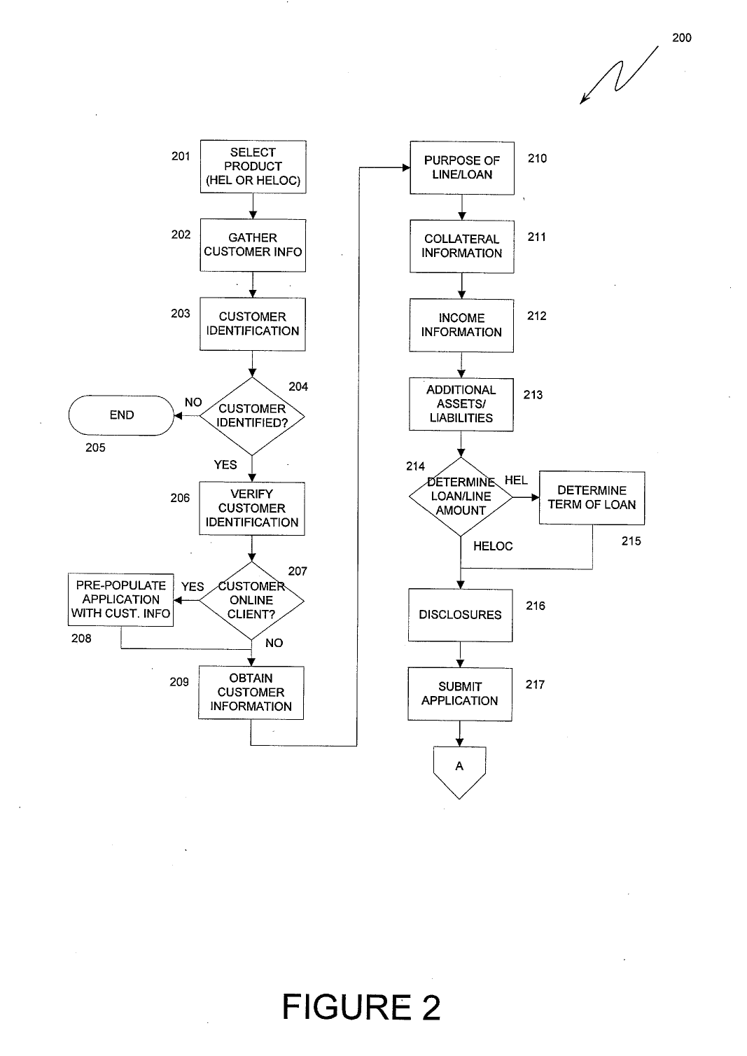

A flow chart 200 is shown in FIG. 2. The flow chart illustrates an additional method for interfacing with a financial institution using a computer interface. The customer enters the system. The products offered on the website may also include more or less detailed descriptions as well as the cost, rates and duration periods. This information may be on the introduction page or accessible from a selectable pop up window or hyperlink. The customer's product selection is made and received by the financial institution or server as shown in Block 201.

In FIG. 2, following receipt of the customer's product selection, a first set of information is collected from the customer as shown in Block 202 and the customer's identity is determined based on the first information as shown in Block 203. If the customer successfully passes the identification authentication, as shown in decision Block 204, the process continues otherwise, either an exception is granted or the application process terminates as shown in Block 205. If the customer is an existing client an exception process may be entered where the customer's application may be placed in a pending status, where continuation of the application is subject to a review process. This additional review process may advantageously include review of the past and current relationship between the financial institution and the customer, as well as other considerations related to the customer's client status. The customer's identification is verified as shown in block 206. The verification may be a presentation back to the customer.

A determination is made in decision Block 207 if the customer is an existing client of the financial institution. If the customer is an existing client, information known to the institution as a result of this relationship is used to pre-populate the relevant application fields for the convenience of the customer as shown in Block 208. In addition to populating fields, portions of the application may be truncated (removed) to make for a shorter application process. Also, if the customer is an existing client, an exception may be granted, where otherwise the process would be terminated (e.g. Block 205). Customers granted an exception and placed in pending status may be manually reviewed by the financial institution, however information and product presentation may continue until the review is completed.

A second set of information may then be requested and received from the customer as shown in Blocks 209-213. This information may include additional customer information, employment history, information regarding the purpose of the lending product, collateral information, customer income information, customer asset information, customer liability information, etc. and combinations thereof.

From this information along with internal financial institution guidelines the loan or credit line amount, if any, may be determined as shown in Block 214. For a loan, the term of the loan may then be established as shown in Block 254. The term may be based on not only the loan amount but also on interest rate, monthly payments or lifetime of the collateral. Disclosures are received from the customer as shown in Block 216 and the application is submitted by the customer to the financial institution as shown in Block 217. The disclosure may also include a consent to obtain financial information, such as a credit history or score, from a third party.

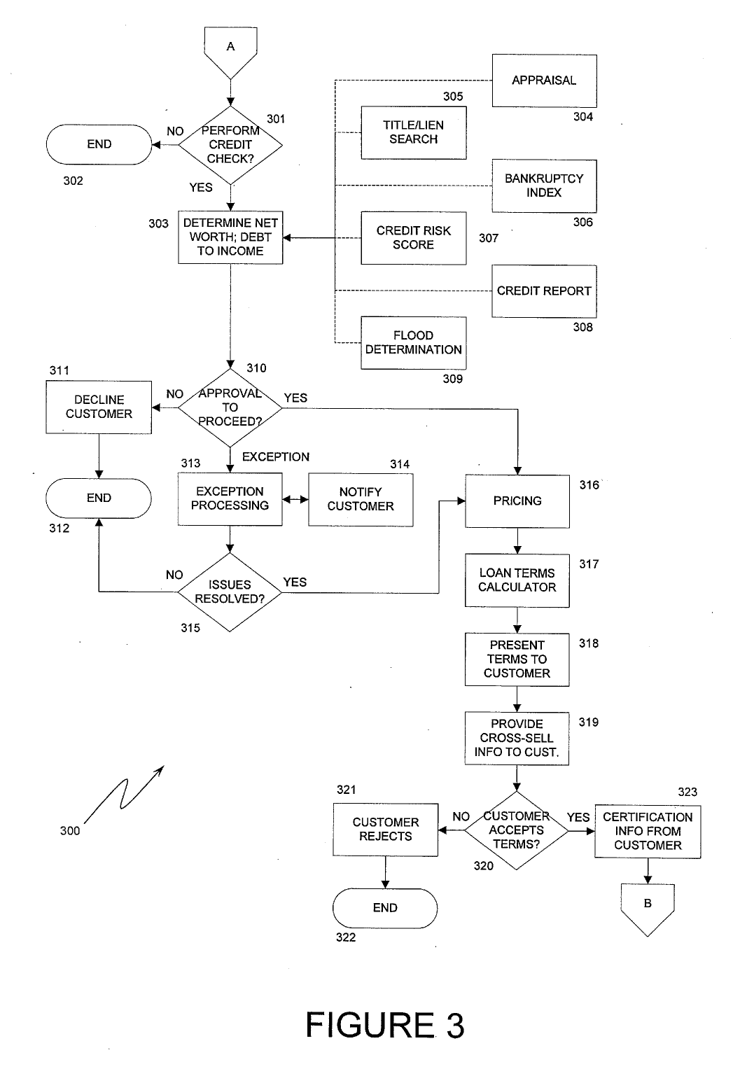

FIG. 3 illustrates additional processes that may be performed by the financial institution in conjunction with the method shown in FIG. 2. These steps are typically considered back room operations that are transparent to the customer. A credit check is performed as shown in Block 301, if because of inaccurate information, or a lack of permission the process may be terminated as shown in Block 302. Alternatively, the customer may be requested to send additional information and/or a grant of permission. In addition to performing a credit check, information gained during the application process is used to obtain information public and private relating to the customers application. This information may be held internally or available from third parties. This information may include title and lien searches on the collateral property if any as well as claimed and unclaimed assets, information regarding the customer's bankruptcy history if any as well as liabilities, a credit score and history to reflect current and past loans, a determination if the property is in a flood zone and other information regarding valuations, appraisals and ability to repay the loan or line of credit as shown in Blocks 304-309.

In addition, a fraud analysis may be performed on the customer, this analysis may include determining if the customer is listed as a fraudster on an internal or external database. The fraud analysis may also include evaluation of the customer's provided information, such as whether the SSN is associated with a person who is deceased, or if the SSN was issued prior to the customer's reported birth date, other checks such as determining if the mailing address is associated with a prison or other notorious entity would also be advantageous. If the fraud analysis presents red flags or warnings the loan approval process may terminate or be prevented from being applied for on-line as discussed above.

This information combined with information supplied by the customers may then be used to determine a net worth of the customer and/or a debt to income ratio for the customer as shown in Block 303. A determination to proceed with the processing of the application is made is Block 310. This determination may be based on information gathered, credit scores or other financial characteristics of the customer or the collateral. If the financial institution does not gain approval to proceed, as a result of a customer not qualifying, the application is declined as shown in Block 311 and the process terminates as shown in Block 312. If there are outstanding issues that need to be addressed before the application processing continues an exception may be made as shown in Block 313. The customer is notified of outstanding issues that have stayed the processing of the application as shown in Block 314. If the issues are subsequently resolved by the customer and or financial institution as shown in decision Block 315, the application approval process continues, otherwise where the issues have not been resolved the application process is terminated as shown in Block 312.

Upon approval of the application, the pricing information for the lending product may be determined as shown in Block 316 and the loan term may be calculated in Block 317. The closing terms and conditions for the lending product are presented to the customer as shown in Block 318. The customer, upon receiving a presentation of the terms and conditions which may include pricing and other cost information makes a determination on whether to accept or reject the lending product in decision Block 320. Prior to the decision, the customer may also be presented with information regarding other products offered by the financial institution or business partners as shown in cross-selling information Block 319. If the terms and conditions of the lending product are rejected as shown in Block 321, the process terminates as shown in Block 322. If the customer accepts the terms and conditions, certification information is received from the customer as shown in Block 323. The certification information may include information regarding insurance, title and collateral. A list of other financial institution products may also be presented to the customer after the completion of the approval of the lending product. In addition, targeted advertisements from third parties may be presented to the customer.

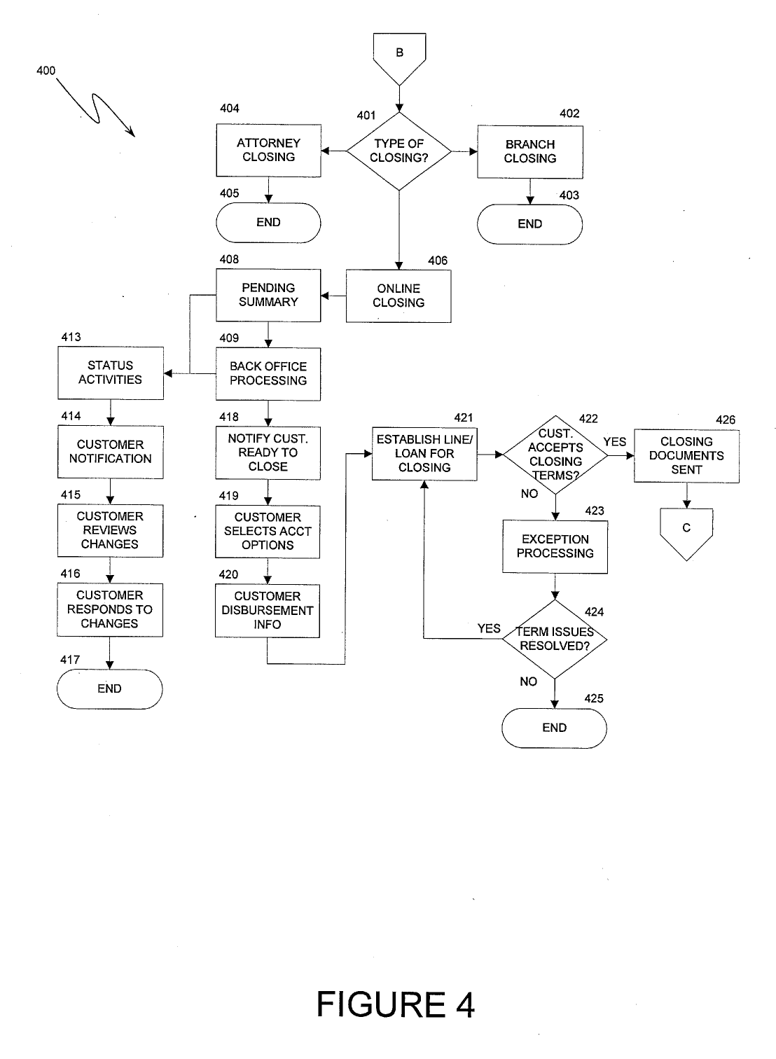

FIG. 4 illustrates processes required in closing a lending product. In Block 401 a type of closing is selected by the customer. If the closing is to be completed at a branch location as shown in Block 402, the on-line processing of the lending product terminates as shown in Block 403. Similarly, if the type of closing selected is that of an attorney closing as shown in Block 404, the on-line processing terminates in Block 405. Information gathered during the on-line phase of the application may still be used in the closing, but active on-line processing is no longer required in these situations. If the customer selects on-line closing as shown in Block 406, a pending summary of the lending product and application is presented to the customer in Block 408. The pending summary highlights the pertinent features, terms and conditions of the lending product for the customer's final review. Back office or back room processing is done by the financial institution or agency thereof as shown in Block 409. This back room processing typically includes pre-closing functions, final underwriting and document preparation. If a change in status of the lending product occurs as shown in Block 413, the customer is notified as shown in Block 414, the customer reviews the changes and responds to the changes in Blocks 415 and 416, respectively. If a change is not accepted or approved by the customer the process terminates as shown in Block 417, otherwise the customer is notified that the lending product is ready for closing as shown in Block 418.

Account options selected by the customer are received as well as customer disbursement information in Blocks 419 and 420 respectively. The closing terms are established for the lending product in Block 421 and are presented to the customer. In decision Block 422, the customer's decision on acceptance of the closings terms is made. If the closing terms are accepted, the closing documents may be sent to the customer as shown in Block 426. These documents may be sent electronically or in hardcopy form (paper). If the terms are not accepted, exception processing may be entered as shown in Block 424. If closing term issues are resolved, the closing terms are again compiled and presented to the customer as shown in Block 421 otherwise the process terminates in Block 425.

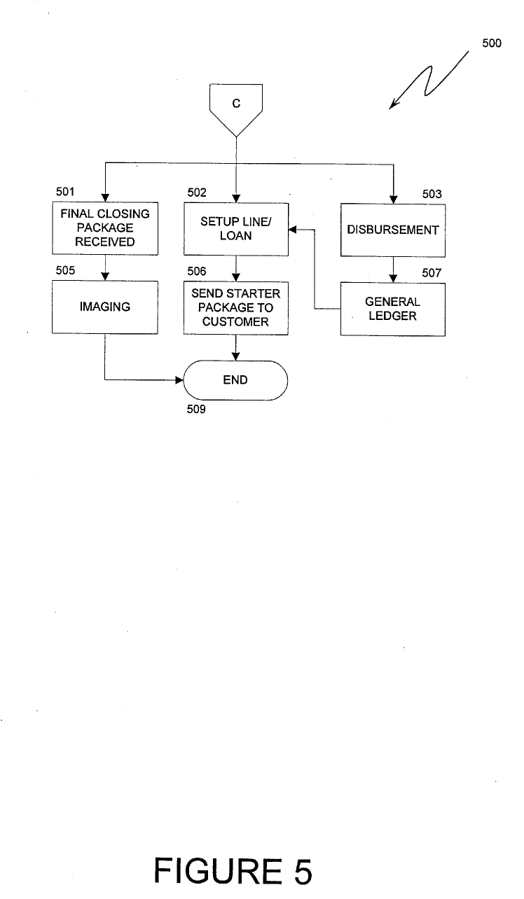

Referring now to FIG. 5, the final closing package may be received as shown in Block 501. The final closing package may include documents in electronic form or in hardcopy. These documents are imaged in Block 505. In Block 502, the lending product may be established, account number assigned etc. and a starter package including installment schedule, deposit slips, checks for credit lines, account numbers is sent to the customer, as shown in Block 506. Disbursements to the benefit of the customer are made by the financial institution as shown in Block 503 and entered into the general ledger in Block 507. The loan application and closing process is then completed as shown in Block 509. Completion of these steps and processes may also be communicated to the customer in an email, SMS, text message, tweet, posting, letter, phone call or other type to indicate completion.

In FIG. 6, a method for authenticating a customer who was determined to be an on-line customer in decision Block 105 of FIG. 1 is shown. The customer may be authenticated as shown in Block 601, the authentication may advantageously include the collection of customer identification information, as discussed previously. If the customer successfully passes the authentication as shown in decision Block 602, a predetermined client identification profile (CIP) for the customer is evaluated as shown in Block 603. The predetermined client identification profile is determined internally from internal and external information such as information from LexisNexis™ products. If the evaluation is acceptable the customer's personal information is displayed on the customer's viewing device as shown in Block 604 and attention is then turned to that of a co-applicant if one is determined, as shown in decision Block 605. Information is collected on the co-applicant in Block 606 and that information is verified as shown in Block 607. Absent a co-applicant, the customer may continue with the application for the selected products at Block 112 in FIG. 1. Generally, the co-applicant is subjected to similar checks as the customer.

If, however, the customer does not pass the customer authentication in decision Block 602, then an additional set of information (INFO1) is requested and entered by the customer. Additional information (INFO2) is also requested in Block 609 if the CIP is found not acceptable in decision Block 603, further processing is described with respect to the CIP outcome in FIG. 7 later. The additional information requested may be identical in both cases. Upon receipt of the additional information, INFO1 or INFO2, a determination of whether there is a co-applicant is made in decision Block 612. If there is a co-applicant, their information is collected and verified in Blocks 613 and 614 respectively, otherwise the application process continues as discussed previously. FIG. 6 also shows that the additional information and co-applicant's information may be edited by the customer any time prior to submission of the application.

Turning to FIG. 7, an alternative method 700 to method 600 in FIG. 6 is shown. If the customer is not determined to be an on-line client, the customer must be identified as shown in Block 108. The method begins following the determination of whether the customer has a good CIP as shown in decision Block 701. If the customer has a good CIP, attention is turned to whether there is a co-applicant. If there is no co-applicant indicated in decision Block 711, then an application may be submitted. The process for a co-applicant will be discussed shortly. A determination that the customer does not have a good CIP in Block 701 results in an evaluation of a first verification index as shown in Block 702. If the first index is found acceptable in decision Block 703, then the customer is queried with one or a series of questions as shown in Block 704. The customer's answers are then verified and a determination of whether they are, or almost are acceptable is made in decision Block 705. If they are acceptable a determination of whether there is a co-applicant is undertaken in Block 711. If the answers are not acceptable then a determination on whether the customer is an existing client is undertaken as shown in Block 708. A third outcome may stem from decision Block 705, the answers may almost be acceptable. In the case of almost acceptable answers, the customer is queried a second time as shown in Block 706 and a yes or no determination of whether these second set of answers are acceptable. If they are not, a determination of whether the customer is an existing client is undertaken in Block 708. If the second set of answers is acceptable, a determination of whether there is a co-applicant is undertaken in Block 711. Continuing with Block 711, if there is no co-applicant then an application may be submitted following a presentation of the terms and condition. If there is a co-applicant in Block 711, then a second verification index is evaluated as shown in Block 712. If the second verification index is found acceptable in decision Block 713 then an application processed may continue in Block 112 of FIG. 1. Otherwise a determination of whether the customer is an existing client is made in decision Block 708. A negative decision reached in Block 708 indicating the customer is not an existing client may lead to a termination of the on-line process as shown in Block 710, whereas a positive decision from Block 708 may lead to a pending status, where approval is subject to, a review process as shown in Block 709. This additional review process may advantageously include review of the past and current relationship between the financial institution and the customer, as well as other considerations related to the customer's client status.

For example, if the name, address, phone number and SSN match, a score reflecting a high matching comparison is given, whereas when one or more of these do not match, a score reflecting a lower matching comparison is applied. The customer is queried regarding answers related to his/her identity for verification. Questions in the query may include for example information typically known only to the individual, such as mother's maiden name, previous address, banking accounts etc.

Each verification index may represent evaluations using a particular set or area of information. The sets or areas of information may or may not be mutually exclusive. One verification index may be based on information which includes searches drawn from public records and directories. Another verification index may be based on the applicant information, for example, name, address, Social Security Number (SSN) and contact information. Yet another verification index may be based on past relationships between the customer and financial institutions. These verification indices may be performed internal by the financial institution or by a third party. The verification indexes may be compared to a predetermined threshold to determine if it is acceptable.

Embodiments of the disclosed subject matter may utilize drop down menus to show the options available to the customer and simplify their selection. Auto fill options may also be utilized for the convenience of the customer. The website format may also be selectable for use in mobile equipment such as Blackberries and PDA equipment, where screen space and functionality may be more limited than on a personal computer. Communications between the customer and the financial institution during the opening of an account may advantageously be encrypted.

The methods of on-line lending may be implemented using various software, hardware and protocols. Additionally information collected via the on-line lending process may be stored in a database for access at a future time. Time outs may also be utilized in the method to require selections and information to be input by the customer be contemporaneous with the requests.

The on-line lending advantageously utilizes real time evaluation of the risks due to fraud and identity by using information previously collected by the institution as well as information obtained from third parties. The decrease in processing times from days to minutes increases the convenience of account opening significantly.

As discussed above, in a typical prior art financial institution online interfacing process, fraud detection and identity verification of a customer opening an online account may not take place until after business hours the day the online account is opened or, perhaps, the next business day after an online account has been set up at the financial institution. Therefore, under certain circumstances, the fraud detection and identity verification of the customer may not take place until four days after an online account is opened. For example if the online account is opened on the Friday before a three-day weekend, the fraud detection and identity verification processes may not take place until the following Tuesday. Obviously, this puts the financial institution in a position of unnecessarily heightened risk. Earlier fraud detection and identity verification processes are necessary to reduce this unnecessary risk to the financial institution. Otherwise a fraudster may have access to a fraudulently-obtained online account for four days before the account is shut down.

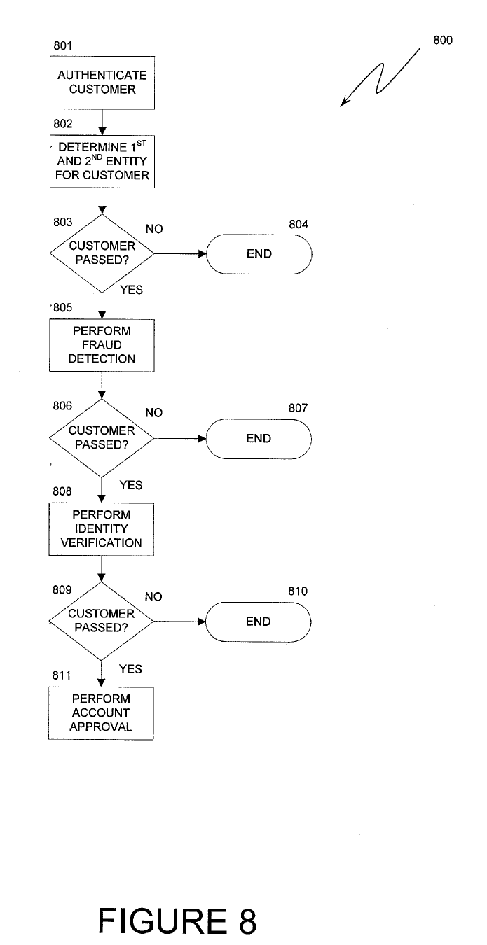

FIG. 8 is a flow chart of an embodiment of a method for interfacing with a financial institution comprising the disclosed early warning system subject matter. Typically, a customer may connect via a computer network (e.g., the internet) to a website for a financial institution and request to interface with the financial institution through the website. The request may be, for example, to open an online business account, as described herein, with the financial institution. The financial institution may receive identification information for the customer and, at Block 801, the financial institution may attempt to authenticate the customer by, among other things, referring to a predetermined client identification profile (“CIP”) The CIP may contain information (public or otherwise) about the customer that was obtained either by the financial institution or for the financial institution from other sources. At Block 802 the financial institution may determine entities associated with the customer. For example, one entity associated with the customer may be identified by the name (as described above) of a “single” or “primary” applicant identified by the customer. Another entity may be identified by the name (as described above) of a “joint” or “secondary” applicant identified by the customer. Other entities besides those listed above are contemplated by this disclosure. Of course, the “name” may also include other identifying information such as address, phone number, tax identification number, a government-issued identification number, etc.

At decision Block 803 a determination may be made as to whether the customer has passed the authentication process. The determination of passing the authentication process may be based on individual checks on one or more of the entities associated with the customer. If the customer did not pass the authentication process, the process may end at Block 804. If the customer did pass the authentication process at decision Block 803, the process may continue to Block 805.

At Block 805 a fraud detection process may be performed on the customer. Details of the fraud detection process appear below. If the customer does not pass the fraud detection process at decision Block 806, the interfacing process may end at Block 807. If the customer passes the fraud detection process at decision Block 806, the customer may undergo an identity verification process as shown at Block 808. Details of the identity verification process appear below. If the customer does not pass the identity verification process at decision Block 809, the interfacing process may end at Block 810. If the customer passes the identity verification process at decision Block 809, the customer may be passed on for an account approval process at Block 811 and from there the customer may continue with the interfacing procedure as described herein.

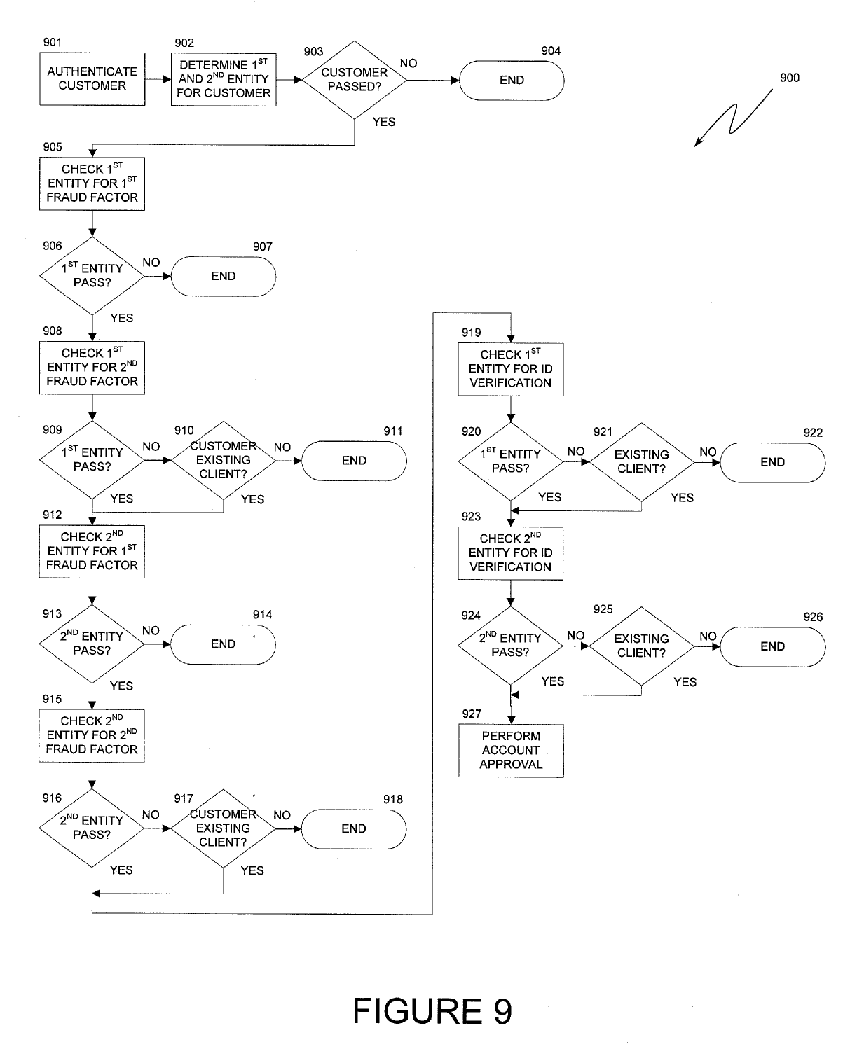

FIG. 9 is a flow chart of another embodiment of a method for interfacing with a financial institution comprising the disclosed early warning system subject matter. Typically, as discussed above, a customer may connect via a computer network (e.g., the internet) to a website for a financial institution and request to interface with the financial institution through the website. The request may be, for example, to open an online retail account, as described herein, with the financial institution. The financial institution may receive identification information for the customer and, at Block 901, the financial institution may attempt to authenticate the customer (as discussed above) by, among other things, referring to a predetermined client identification profile (“CIP”) The CIP may contain information (public or otherwise) about the customer that was obtained either by the financial institution or for the financial institution from other sources. At Block 902 the financial institution may determine entities associated with the customer as discussed above. At decision Block 903 a determination may be made as to whether the customer has passed the authentication process, as discussed above. The determination of passing the authentication process may be based on individual checks on one or more of the entities associated with the customer. If the customer did not pass the authentication process, the process may end at Block 904.

At Block 905 an evaluation may be made for a first entity (which may preferable be a single applicant associated with the customer as discussed above) for a first fraud factor. If the first entity does not pass the first fraud factor evaluation at decision Block 906, the process may end at Block 907; otherwise an evaluation may be made for the first entity for a second fraud factor at Block 908. The first fraud factor (sometimes referred to herein as an “LRM Hot File” or “Hot File”) may preferably be a list of known fraudsters and/or abusers at the financial institution and may include former clients of the financial institution who have been “exited” from the financial institution, e.g., those who had an account closed by the financial institution due to various activity of the former client. The second fraud factor (sometimes referred to herein as a “Shared Fraud Database” or “Shared Fraud”) may preferably be a list containing information from the financial institution and/or other financial institutions about known fraudsters and/or abusers and/or other clients (former or otherwise) who for some reason have been exited from a financial institution.

Returning attention back to FIG. 9, at decision Block 909 a determination may be made as to whether the first entity passed the second fraud factor evaluation. If the first entity does not pass the second fraud factor evaluation at decision Block 909, at decision Block 910 if the customer is not an existing client at the financial institution then the process may end at Block 911. Otherwise, if the first entity passes the second fraud factor evaluation at decision Block 909 or if the customer is an existing client at decision Block 910, an evaluation may be made for a second entity (which may preferable be a joint applicant associated with the customer as discussed above) for the first fraud factor at Block 912.

If the second entity does not pass the first fraud factor evaluation at decision Block 913, the process may end at Block 914; otherwise an evaluation may be made for the second entity for the second fraud factor at Block 915. At decision Block 916 a determination may be made as to whether the second entity passed the second fraud factor evaluation. If the second entity does not pass the second fraud factor evaluation at decision Block 916, at decision Block 917 if the customer is not an existing client at the financial institution then the process may end at Block 918. Otherwise, if the second entity passes the second fraud factor evaluation at decision Block 916 or if the customer is an existing client at decision Block 917, the process may continue to Block 919.

At Block 919 the first entity may be evaluated for identity verification. The identity verification may include a validation of the first entity's name and address given to the financial institution during the online interfacing procedure. The identity verification may also include validation of other information given to the financial institution by the customer during the online interfacing procedure. In a preferred embodiment, the customer and/or an entity associated with the customer may be given a “score” for the identity verification evaluation and that score may be compared with a predetermined threshold value. The threshold value may be the same for all entities or one or more of the threshold values may be different than the threshold values of the other entities. In a preferred embodiment, an entity's identity verification evaluation score which exceeds the appropriate threshold may indicate failure of the identity verification evaluation. If the first entity does not pass the identity verification evaluation at decision Block 920, at decision Block 921 if the customer is not an existing client at the financial institution then the process may end at Block 922. Otherwise, if the first entity passes the identity verification evaluation at decision Block 920 or if the customer is an existing client at decision Block 921, the second entity may be evaluated for identity verification at Block 923. If the second entity does not pass the identity verification evaluation at decision Block 924, at decision Block 925 if the customer is not an existing client at the financial institution then the process may end at Block 926. Otherwise, if the second entity passes the identity verification evaluation at decision Block 924 or if the customer is an existing client at decision Block 925, the process may continue to performing an account approval evaluation at Block 927 and from there may follow the online account opening procedure described above.

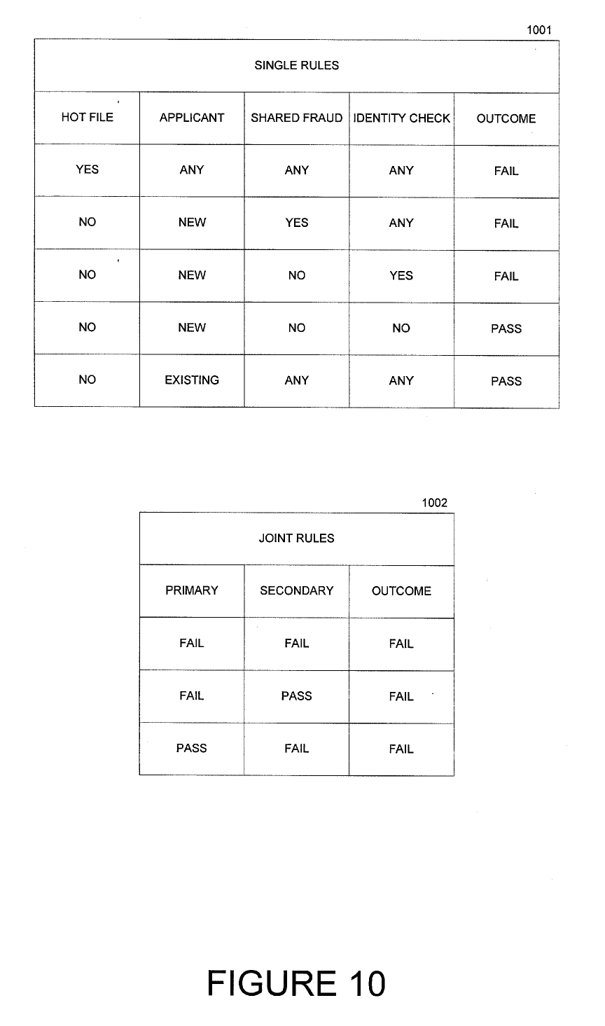

FIG. 10 is a table representing single applicant rules and joint applicant rules for an embodiment of an early warning system of the disclosed subject matter. FIG. 10 is a table 1001 representing single rules and a table 1002 representing joint rules for an embodiment of an early warning system/methodology of the disclosed subject matter. With reference to table 1001, the first column lists results for the Hot File evaluation, the second column lists whether the customer (or applicant) is an existing client of the financial institution, the third column lists results for the Shared Fraud evaluation, the fourth column lists results for the identity verification evaluation, and the fifth column lists the overall outcome of the evaluation given the results in the first four columns. As an example for following the logic in table 1001, assume that the single applicant associated with the customer is referred to as the first entity. Then, for the first of the five rows of results that appears in table 1001, if the first entity fails the Hot File evaluation (i.e., the first entity appears on the Hot File) the overall outcome is that the customer will “fail”, i.e., the customer will not be allowed to continue with the online interfacing procedure. In this case, this result will occur regardless of any other evaluations that may be performed or the status of the customer as a new or existing client of the financial institution. For the second row of results, if the first entity fails the Shared Fraud evaluation and if the customer is a new client of the financial institution (i.e., the customer is not an existing client) then the overall outcome is “fail”. For the third row of results, if the first entity fails the identity verification evaluation (i.e., the score exceeds a predetermined threshold as discussed above) and if the customer is a new client, the overall outcome is “fail”. For the fourth row of results, if the first entity passes the Hot File, Shared Fraud, and identity verification evaluations and is a new client, the overall outcome is “pass”. For the fifth row of results, if the first entity is an existing client and passes the Hot File evaluation the overall outcome is “pass” regardless of the results of the Shared Fraud and identity verification evaluations. If there is a secondary or joint applicant, the secondary applicant (which may be the second entity) is also evaluated as described above for the first entity.

For table 1002, the outcomes for the first and second entity (listed as “primary” and “secondary”, respectively), for example, determined in table 1001 are then entered in the first two columns of table 1002, respectively, and an overall outcome is shown in the third column. As can be seen in table 1002, if either or both of the primary and secondary applicants “fail”, the overall outcome for the customer is “fail”. Only if both the primary and secondary applicants “pass” (as shown in the bottom row of table 1002) is the overall outcome for the customer “pass” (i.e., the customer can continue with the online retail account opening process).

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal thereof.

What is claimed is:

1. A method of interfacing with a financial institution using a computer interface, the method comprising the steps of:
(a) receiving an interface request from a customer after the customer has reached, via a path through a computer network, a predetermined webpage for the financial institution;
(b) receiving identification information from the customer;
(c) authenticating the customer based at least in part on an evaluation of a predetermined client identification profile (“CIP”);
(d) determining a first and a second entity for the customer;
(e) determining if the customer passes the authentication and if not stopping the interfacing procedure;
(f) performing a fraud detection analysis on the customer and stopping the interfacing procedure if the customer does not pass the fraud detection analysis;
(g) performing an identity verification analysis on the customer and stopping the interfacing procedure if the customer does not pass the identity verification analysis; and
(h) performing an account approval process.

2. A method of interfacing with a financial institution using a computer interface, the method comprising the steps of:
(a) receiving an interface request from a customer after the customer has reached, via a path through a computer network, a predetermined webpage for the financial institution;
(b) receiving identification information from the customer;
(c) authenticating the customer based at least in part on an evaluation of a predetermined client identification profile (“CIP”);
(d) determining a first and a second entity for the customer;
(e) determining if the customer passes the authentication and if not stopping the interfacing procedure;
(f) evaluating the first entity against a first fraud factor and stopping the interfacing procedure if the first entity does not pass the first fraud factor analysis;
(g) evaluating the first entity against a second fraud factor and if the first entity does not pass the second fraud factor analysis determining if the customer is an existing client of the financial institution and if the customer is not an existing client of the financial institution then stopping the interfacing procedure;
(h) evaluating the second entity against the first fraud factor and stopping the interfacing procedure if the second entity does not pass the first fraud factor analysis;
(i) evaluating the second entity against the second fraud factor and if the second entity does not pass the second fraud factor analysis determining if the customer is an existing client of the financial institution and if the customer is not an existing client of the financial institution then stopping the interfacing procedure;
(j) comparing an identity verification score for the second entity against a second predetermined threshold and if the identity verification score for the second entity is greater than the second threshold determining if the customer is an existing client of the financial institution and if the customer is not an existing client of the financial institution then stopping the interfacing procedure;
(k) comparing an identity verification score for the first entity against a first predetermined threshold and if the identity verification score for the first entity is greater than the first threshold determining if the customer is an existing client of the financial institution and if the customer is not an existing client of the financial institution then stopping the interfacing procedure; and
(l) performing an account approval process.

3. The method of claim 1 wherein the first entity is a sole or primary applicant associated with the customer and the second entity is a secondary or joint applicant associated with the customer.

4. The method of claim 2 wherein the first entity is a sole or primary applicant associated with the customer and the second entity is a secondary or joint applicant associated with the customer.

5. The method of claim 2 wherein the first fraud factor is a list comprising known fraudsters identified by the financial institution and the second fraud factor is a database of known fraudsters or abusers identified by the financial institution or a second financial institution.

6. The method of claim 5 wherein the first and second thresholds are different.

7. The method of claim 1, wherein the interface request received from the customer is an electronic lending request.

8. The method of claim 2, wherein the interface request received from the customer is an electronic lending request.
